(19) United States
(12) Patent Application Publication
(10) Pub. No.: US 2026/0167065 A1
(43) Pub. Date: Jun. 18, 2026

(54) MOTOR VEHICLE WITH ADAPTIVE REAR BENCH

(71) Applicant: American Honda Motor Co., Inc., Torrance, CA (US)

(72) Inventors: Jean-Hugues Tuan Huy NGUYEN, Los Angeles, CA (US); Minjae KIM, Los Angeles, CA (US); Romain Daniel Charles MIVELLE, Los Angeles, CA (US)

(21) Appl. No.: 18/982,568

(22) Filed: Dec. 16, 2024

(51) Int. Cl. B60N 2/06; B60N 2/02

(52) U.S. Cl. CPC B60N 2/065; B60N 2/0248

(57) ABSTRACT

An adaptive rear bench changes configurations according to different front seat configurations or driving modes. The rear bench comprises an adaptive geometry that may be adjusted to provided different types of seating and/or room for storing cargo. The rear bench may comprise a plurality of internal support members and at least one outer covering layer. The surface geometry of the rear bench may be adjusted.

### BACKGROUND

The present disclosure relates to motor vehicles, and in particular to seating for motor vehicles.

Motor vehicles include various systems that are adapted to user preferences and performance needs. These may include the use of displays, audio systems, and HVAC systems that provide comfort and entertainment. Some motor vehicles may also be operated in different modes, for example, in an autonomous driving mode and a manual driving mode. In some cases, rear seating in a vehicle may be changed. However, these adjustments are typically made by adjusting seatbacks, sliding the seats, or stowing seats. In particular, the configuration of rear seating, especially in vehicles with a rear bench, cannot be adjusted dynamically to accommodate driving modes and/or storage needs.

There is a need in the art for a system and method that addresses the shortcomings discussed above.

### SUMMARY

Embodiments provided herein disclose systems and methods for an adaptive rear bench in a motor vehicle. The adaptive rear bench may be automatically adjusted to have different configurations, including different geometries, according to the configuration of the front seats and/or the current vehicle driving mode.

In some aspects, the techniques described herein relate to a motor vehicle, including: a front seat having a first seat configuration and a second seat configuration; a rear bench having a first bench configuration and a second bench configuration; a control system to: automatically adjust the rear bench to have the first bench configuration when the front seat has the first seat configuration; and automatically adjust the rear bench to have the second bench configuration when the front seat has the second seat configuration.

In some aspects, the techniques described herein relate to a motor vehicle, including: a rear bench further including: a plurality of support members, wherein the plurality of support members are independently moveable in a first direction; at least one outer covering layer disposed over one or more of the plurality of support members; wherein a geometry of the rear bench changes as the plurality of support members are moved to different positions along the first direction.

In some aspects, the techniques described herein relate to a motor vehicle, including: a rear bench including an exterior surface; and wherein a surface geometry of exterior surface is adjustable.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIGS. 1 and 2 show schematic views of an interior cabin of a motor vehicle, according to an embodiment.

FIGS. 3A-B illustrate in further detail different configurations of a rear bench, according to an embodiment.

FIGS. 4A-B illustrate schematic side views showing exemplary interior and exterior components for a rear bench, according to an embodiment.

FIG. 5 illustrates a schematic side view showing exemplary interior and exterior components for a rear bench, according to another embodiment.

FIGS. 6 and 7 are schematic views of an embodiment of an internal support assembly for a rear bench, according to an embodiment.

FIGS. 8 and 9 show top-down views of an exemplary support member having a plurality of adjustable segments, according to an embodiment.

FIG. 10 illustrates a geometry for a rear bench that may be used with a performance mode, according to an embodiment.

FIG. 11 is a schematic view of a system diagram of some components of a motor vehicle that may facilitate operation of an adaptive rear bench, according to an embodiment.

### DETAILED DESCRIPTION

The exemplary embodiments may be make use of any of the systems, components, methods or other provisions disclosed in U.S. Serial Number yy/yyy,yyy, (attorney docket 48-1869), filed concurrently with the present application, to Nguyen et al., and titled “Motor Vehicle with Adaptive Seating System,” which is incorporated by reference herein in its entirety.

The embodiments provide systems and methods for an adaptive rear bench that may change configurations according to different front seat configurations, driving modes, user preferences, or other considerations. The adaptive rear bench has an adaptive geometry that may be adjusted to provided different types of seating and/or room for storing cargo. In some cases, the adaptive rear bench may be extended to provide seating. In some cases, at least some portions of the rear bench may be retracted to provide additional cargo room. In some embodiments, the rear bench may be comprised of a plurality of internal support members and one or more outer covering layers. The positions of the internal support members may be adjusted, for example, along a horizontal direction, and the one or more outer covering layers may stretch or otherwise change shape to adapt to the positions of the internal support members. This allows the size and shape of the rear bench, including the size and shape of the lower seating portion, the rear portion and side portions of the rear bench, to be adjusted dynamically to adapt to the needs of one or more occupants.

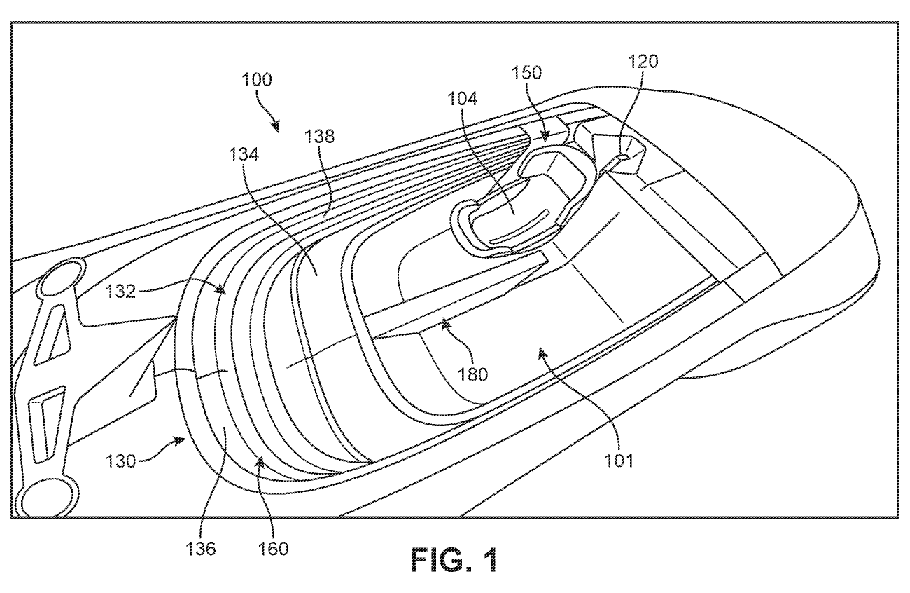

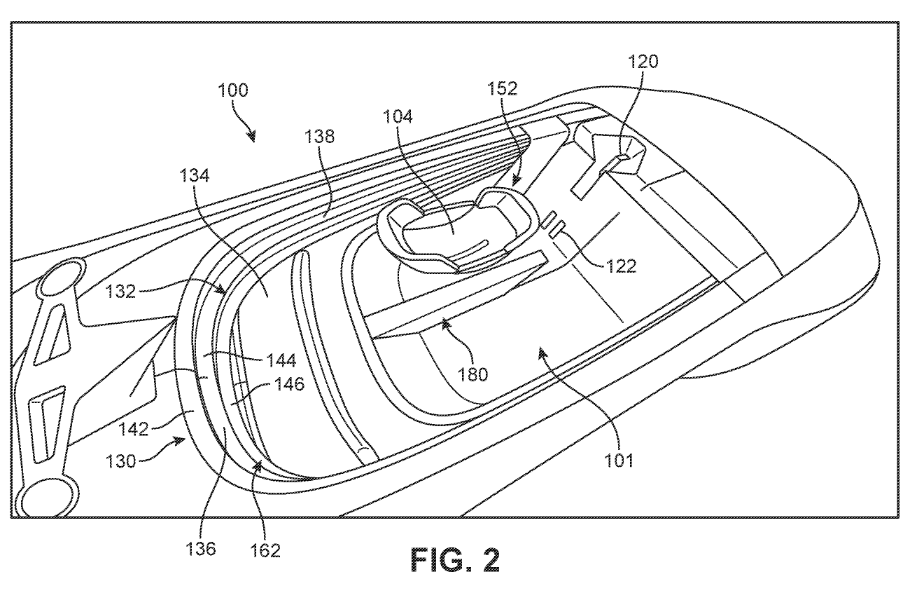

FIGS. 1 and 2 show schematic views of an interior cabin 101 of a motor vehicle 100. The vehicle 100 may be a non-autonomous vehicle, a semi-autonomous vehicle, or fully autonomous vehicle, for example, as defined by National Highway Traffic Safety Administration (NHTSA). Examples of vehicles that may be used with the embodiments include, but are not limited to, a three-wheeler vehicle, a four-wheeler vehicle, a hybrid vehicle, or a vehicle with autonomous drive capability that uses one or more distinct renewable or non-renewable power sources. Vehicles may use renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicles may have load carrying capabilities that uses one or more distinct trailers.

As seen in FIGS. 1-2, interior cabin 101 includes a front seat 104. For purposes of illustration, only a single ‘driver’ seat is shown in FIG. 1. However, in other embodiments, interior cabin 101 may also include one or more ‘passenger’ seats. Interior cabin 101 may also include deployable steering controls 120 and acceleration/braking controls 122 (see FIG. 2).

Interior cabin 101 may further include a rear seating region 130 including a rear bench 132. Rear bench 132 may comprise one or more surfaces that facilitate seating passengers and/or for placing cargo. In particular, rear bench 132 may include a lower support surface 134, a rear support surface 136, and opposing lateral support surfaces 138. In an exemplary embodiment, as shown in FIGS. 1-2, rear support surface 136 and lateral support surfaces 138 may be substantially continuous and together may form a single peripheral surface of rear bench 132. Taken together, lower support surface 134, along with the peripheral surface, may be collectively referred to as the ‘exterior surface’ of rear bench 132.

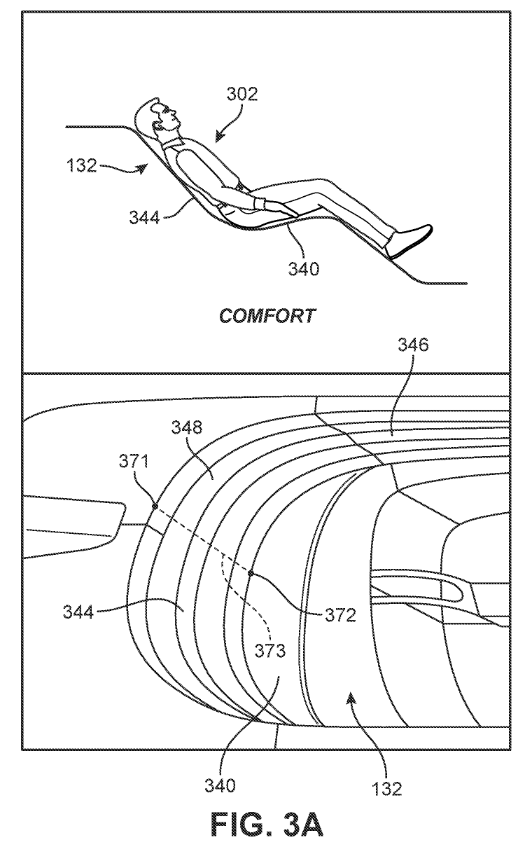

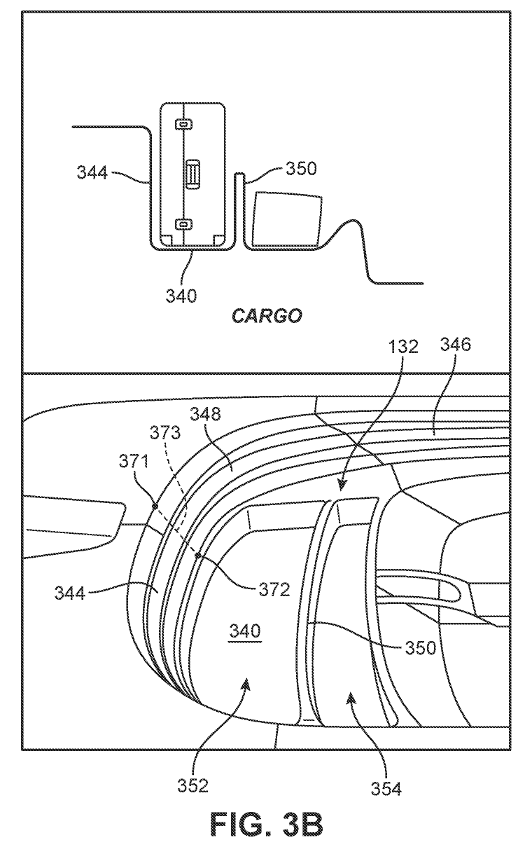

In cases where rear bench 132 is used for seating, lower support surface 134 may provide support to an occupant’s legs, while rear support surface 136 may provide support to an occupant’s back. In some cases, lateral support surfaces 138 may provide support to an occupant’s arms. In other cases, these same support surfaces may be used to hold cargo. For example, lower support surface 134 and rear support surface 136 may form a compartment to hold and constrain the movement of cargo (see FIG. 3B).

In some embodiments, some of the surfaces of rear bench 132 may be formed by stacking individually adjustable components. In FIGS. 1-2, the peripheral surface of rear bench 132, comprising both rear support surface 136 and lateral support surfaces 138, may be associated with distinct bolster portions. For example, as best seen in FIG. 2, rear bench 132 may comprise a first bolster portion 142, a second bolster portion 144, and a third bolster portion 146. These bolster portions comprise individually adjustable components whose positions can be dynamically adjusted to change the shape of one or more surfaces of rear bench 132. Moreover, these bolster portions may provide both sufficient cushioning and firmness for supporting an occupant.

As discussed in further detail below, the geometry of rear bench 132 may be highly adaptive such that the shape of its exterior surface may change significantly from one configuration to another. Moreover, because rear bench 132 may be comprised of different components that are extended and retracted dynamically, the lower and peripheral surfaces for any given configuration may be associated with different physical components of the rear bench, and are therefore understood to be defined according to their relative positions and utility.

Both front seat 104 and rear bench 132 may have adaptable positions and/or configurations. For example, front seat 104 is configurable in at least a first front seating position 150 (in FIG. 1) and a second front seating position 152 (in FIG. 2). Front sear 104 may rotate about its base to change between first front seating position 150 and second front seating position. Rear bench 132 is configurable in at least a first bench configuration 160 (in FIG. 1) and a second bench configuration 162 (in FIG. 2). First bench configuration 160 may be depicted in FIG. 3A and second bench configuration 162 may be depicted in FIG. 3B in isometric views.

In some embodiments, both front seat 104 and rear bench 132 may have an adaptable configuration that can be changed according to different uses, passenger preferences, driving modes and/or seating modes. As an example, motor vehicle 100 may be configured to operate in one or more modes. For example, motor vehicle 100 may be operated in an “autonomous driving mode”, a “manual driving mode”, and a “sport mode”. In the manual and sport driving modes, occupants may interact with steering controls 120 and/or acceleration/braking controls 122 to steer, drive, and brake motor vehicle 100. By contrast, in the autonomous driving mode, the occupants may not interact with any controls. In some cases, motor vehicle 100 may be operated in a “parking mode”, also referred to as a “welcome mode”. This mode may be used while the vehicle is parked or otherwise not moving. Still other modes are contemplated, including a sport or performance mode, which may provide more vehicle power, acceleration, deceleration, or responsiveness, or performance than the manual driving mode.

In some cases, the configuration of front seat 104 and/or rear bench 132 may change for different driving modes. For example, in FIG. 1, motor vehicle 100 may be in a “welcome mode” while the vehicle is parked. In the welcome mode occupants may be encouraged to face one another and interact. In the welcome mode, front seat 104 may be positioned so the driver is facing towards a central region 180 of interior cabin 101. Likewise, in this welcome mode, rear bench 132 may have a configuration that allows other passengers to sit and relax on rear bench 132 as they are also facing towards central region 180 of interior cabin 101.

In FIG. 2, motor vehicle may be in a driving mode, including either an autonomous driving mode, manual driving mode, or sport mode. In either case, in this mode front seat 104 may be repositioned to face forwards (for example, towards a windshield and/or front of the vehicle) so that the driver can access steering controls 120 (once they have deployed) and/or keep an eye on the road. Additionally, in this driving mode, rear bench 132 may have a configuration that facilitates using the rear seating region 130 for cargo. Specifically, in this second bench configuration, first bolster portion 142, second bolster portion 144, and third bolster portion 146 may be retracted to provide more space for cargo behind front seat 104.

FIGS. 3A and 3B illustrate in further detail how the rear bench 132 is adapted to have different shapes that achieve different functionality. In FIG. 3A, rear bench 132 has a geometry comprised of a lower support surface 340 and a rear support surface 344. Lower support surface 340 is shaped to accommodate the legs of an occupant 302, while rear support surface 344 accommodates the occupant’s back. In particular, rear support surface 344 is inclined at an angle such that occupant 302 may lay back while sitting on rear bench 132. In the configuration of FIG. 3A, rear support surface 344 and lateral support surfaces 346 are comprised of individual bolster portions 348 that may be staggered in a horizontal direction. Moreover, lower support surface 340 may comprise a substantially rigid layer of material that can support occupant 302.

In FIG. 3B, the geometry of rear bench 132 has been modified to accommodate cargo. Specifically, in this configuration, the portion of reach bench 132 that formed lower support surface 340 in FIG. 3A has been retracted, revealing an underlying surface that functions as the adapted lower support surface 340. Also, rear bench 132 includes a raised divider 350 to separate the rear seating region into a first compartment 352 and a second compartment 354. Likewise, rear support surface 344 is adapted to have a more vertical shape, compared to the inclined shape of rear support surface 344 in the configuration of FIG. 3A, thereby providing additional room for storage. In particular, the bolster portions 348 comprising rear support surface 344 and lateral support surfaces 346 are less staggered in the horizonal direction.

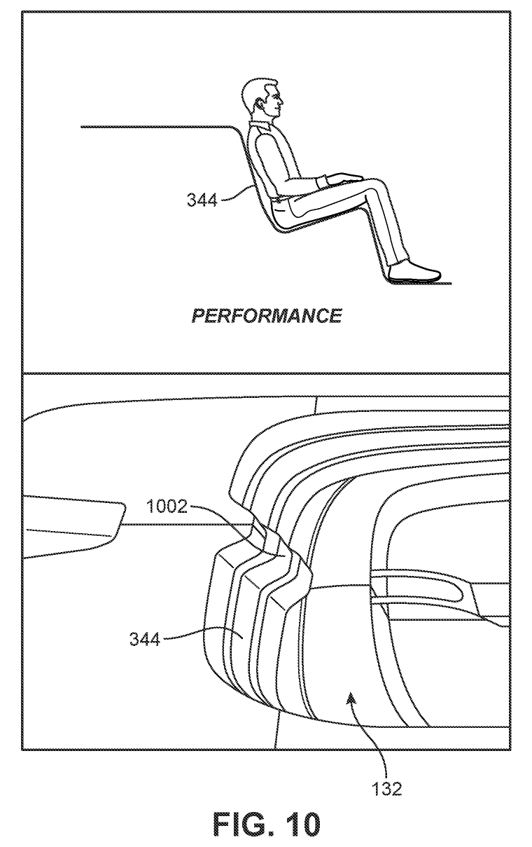

It may be appreciated that the different geometric configurations of rear bench 132 are not merely accounted for by shifts in the orientations of different components, as may occur when a conventional vehicle seat is inclined, for example. Instead, the change in geometric configuration is associated with changes in the surface geometry of the rear bench. For example, in changing from the configuration shown in FIG. 3A to the configuration shown in FIG. 3B, rear support surface 344 does not merely change orientation, but the surface area of rear support surface 344 is reduced. This may be understood by considering that the overall height of rear support surface 344 does not change as the incline of the surface changes, whereas in a conventional seat the height of the seat changes as it is reclined or placed upright. Instead, the linear distance between two points of rear support surface 344 changes as the inclination of rear support surface 344 changes. For example, in FIGS. 3A-B, a linear distance 373 between a first point 371 associated with a top bolster portion of rear support surface 344 and a second point 372 associated with a bottom bolster portion of rear support surface 344 decreases from the first configuration of FIG. 3A to the second configuration of FIG. 3B. Thus, the surface geometry, including curvature and relative distances between different portions, may change between different configurations of rear bench 132. Moreover, in some cases, the curvature of the surfaces changes, as discussed in further detail below and shown, for example, in FIG. 10.

In some embodiments, an adaptive rear bench may be implemented using a combination of internal support members and flexible exterior components. In one embodiment, a plurality of internal support members may be covered by one or more outer covering layers. The plurality of support members may have relative positions that are adjustable along one or more dimensions. As the plurality of support members are moved to different positions, the outer covering layers may stretch, contract, or otherwise flex to accommodate the changed support member positions while providing a continuous and coherent outer/exterior surface for the rear bench. This creates an adaptive exterior geometry for the rear bench that may provide different configurations for seating, storage, or other uses.

In some embodiments, a rear bench may be comprised of stacked layers that can be moved/adjusted along one or more linear dimensions. In some cases, each layer is comprised of a support member. Each layer may further include a covering layer that covers over a corresponding support member. Each layer may then be extended or retracted to change the overall geometry of the rear bench.

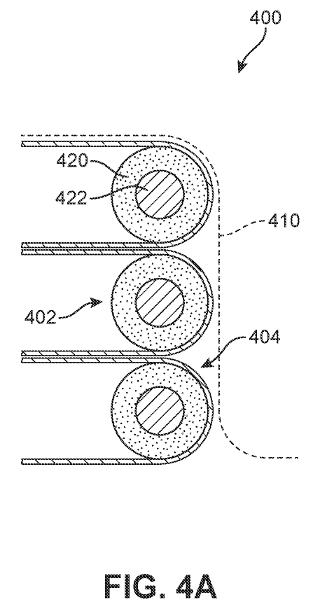

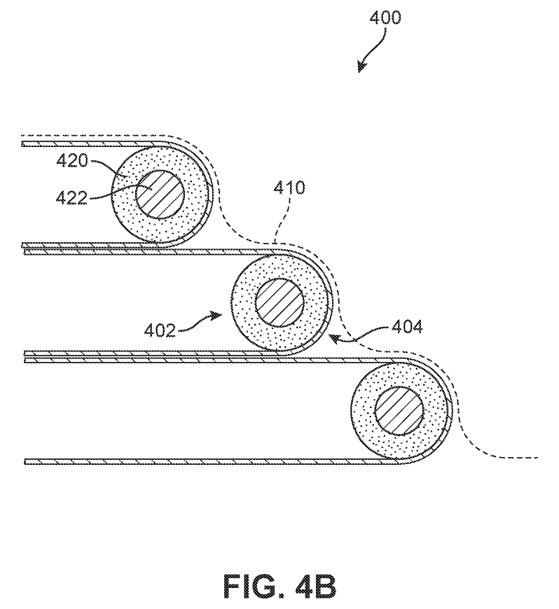

FIGS. 4A and 4B illustrate schematic side views showing an exemplary implementation for a rear bench 400. For purposes of clarity, only some portions of rear bench 400 are shown. Specifically, a portion that may correspond to a rear support surface of rear bench 400 is shown.

In this example, rear bench 400 includes a plurality of support members 402. In an exemplary embodiment, each of the support members 402 is associated with a separate outer covering layer, which together comprise plurality of outer covering layers 404. Although the present embodiments depict separate covering layers for each internal structure, in other embodiments a single outer covering layer could be used to two or more internal structures.

In some cases, the plurality of support members 402 may be relatively rigid or firm to provide support. For example, plurality of support members 402 may comprise bolster-like structures that provide support to the back of an occupant. In some cases, support members 402 comprise outer cushioning portions 420 and inner support portions 422. Outer cushioning portions 420 may facilitate comfort for seating, while inner support portions 422 provide the structural integrity needed to support weight and for interfacing with other dynamic components of the system, such as rods, linkages, or other actuating components.

By contrast with the relatively rigid support members, the plurality of outer covering layers 404 may be relatively elastic, and may stretch as the plurality of support members 402 move relative to one another. Thus, the plurality of outer covering layers 404 are seen to stretch as the plurality of support members 402 move from a vertically aligned configuration in FIG. 4A to a horizontally spaced configuration in FIG. 4B. As the relative positions of the plurality of support members 402 are changed and the outer covering layers 404 stretch (or contract) accordingly, the resulting geometry of the outer surface of rear bench 400 is seen to change. For example, in FIG. 4A, the configuration provides a relatively vertical support surface 410 for an occupant’s back (or for cargo), while in FIG. 4B, the configuration provides an inclined support surface 410 for an occupant’s back (or for cargo).

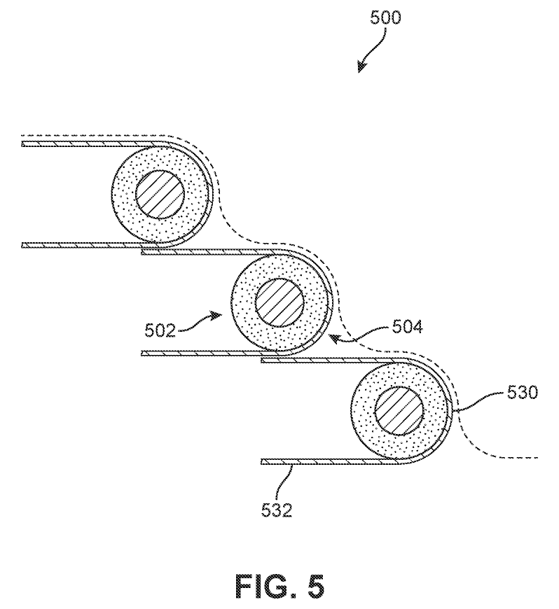

In another embodiment, the outer covering layers may not stretch. Instead, the covering layers may simply slide with the plurality of support members 402, while retaining fixed dimensions. For example, in another embodiment of a rear bench 500, shown in FIG. 5, outer covering layers 504 may be relatively inelastic in the direction of sliding (for example, in a direction towards the front of the vehicle). Instead of stretching, each of the outer covering layers 504 may slide along with plurality of support members 502. In particular, the rearmost portions 532 of the outer covering layers 504 may translate along with the frontmost portions 530 of the outer covering layers 504 as the plurality of support members 502 move.

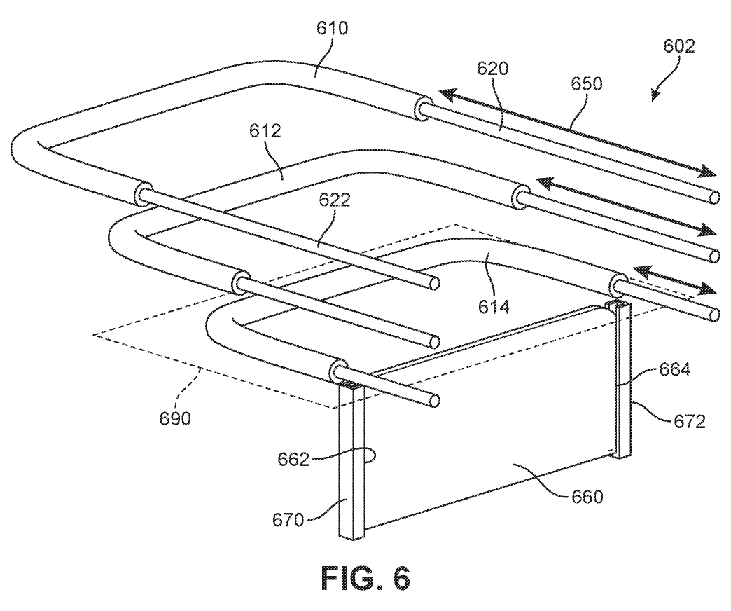

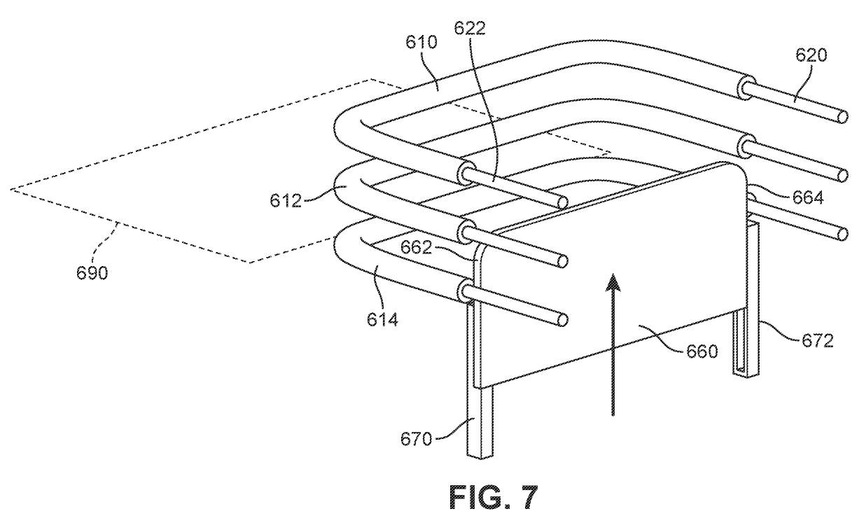

FIGS. 6 and 7 are schematic views of an embodiment of an internal support assembly 602 for a rear bench. For purposes of illustration, outer covering layers of the rear bench are not shown in FIGS. 6-7.

As seen in FIG. 6, internal support assembly 602 includes a first support member 610, a second support member 612, and a third support member 614. Each support member comprises a tube-like support structure with a curved geometry, such as a U-shape, which may provide support along the sides and rear surfaces of a bench. Each support member may be further connected to support rods, which may be used to translate the corresponding support member in an approximately horizontal direction. For example, first support member 610 is attached at a first end to first rod 620 and at a second end to second rod 622. First rod 620 and second rod 622 may be translated along a horizontal direction 650 using a suitable actuating system (not shown). Similarly, each of second support member 612 and third support member 614 may be attached to corresponding rods, which are themselves translated along direction 650 using suitable actuating mechanisms. In some cases, direction 650 may be a horizontal direction. In some cases, direction 650 may be a longitudinal direction that extends from a front side to a rear side of a vehicle.

In some embodiments, internal support assembly 602 may also include a dividing member 660. Dividing member 660 may comprise a panel-like structure that may be raised and lowered on rails. Specifically, a first edge 662 of dividing member 660 may be mounted to first rail 670 and a second edge 664 of dividing member 660 may be mounted to second rail 672. Using a suitable actuating system (not shown), dividing member 660 may be raised and lowered along first rail 670 and second rail 672. In some cases, first rail 670 and second rail 672 may be integrated into a floor of a vehicle so that dividing member 660 may be raised from and lowered into the floor.

FIGS. 6 and 7 also illustrate an optional support layer 690. Support layer 690 may be a relatively rigid layer that has sufficient strength to support an occupant. In some cases, when dividing member 660 is retracted as in FIG. 6, support layer 690 may be moved forward to provide a relatively higher seat for rear bench 132 than the floor. However, in the cargo configuration of FIG. 7, support layer 690 may be retracted to provide a greater depth for cargo storage.

The configuration of internal support assembly 602 in FIG. 6 may approximately correspond to the geometry of rear bench 132 as shown in FIG. 3A. Specifically, with the support members staggered in the horizontal direction, the geometry of rear support surface 344 is relatively inclined. Moreover, support layer 690 is extended to provide lower support surface 340 to support an occupant’s legs. Also, dividing member 660 is retracted beneath support layer 690.

The configuration of internal support assembly 602 in FIG. 7 may approximately correspond to the geometry of rear bench 132 as shown in FIG. 3B. Specifically, with the support members approximately aligned in a vertical direction (and retracted towards a rearward end of the motor vehicle), the geometry of rear support surface 344 is near vertical, or significantly steeper than the inclination angle of the surface in FIG. 3A. Moreover, diving member 660 is extended and support layer 690 has been retracted to provide two relatively deep storage compartments.

The embodiments may utilize any suitable actuating systems for adjusting the positions of support members. These may include motors, linkages, chains, or other components that may be used to push/pull and/or retract/extend support members and dividing members along one or more dimensions.

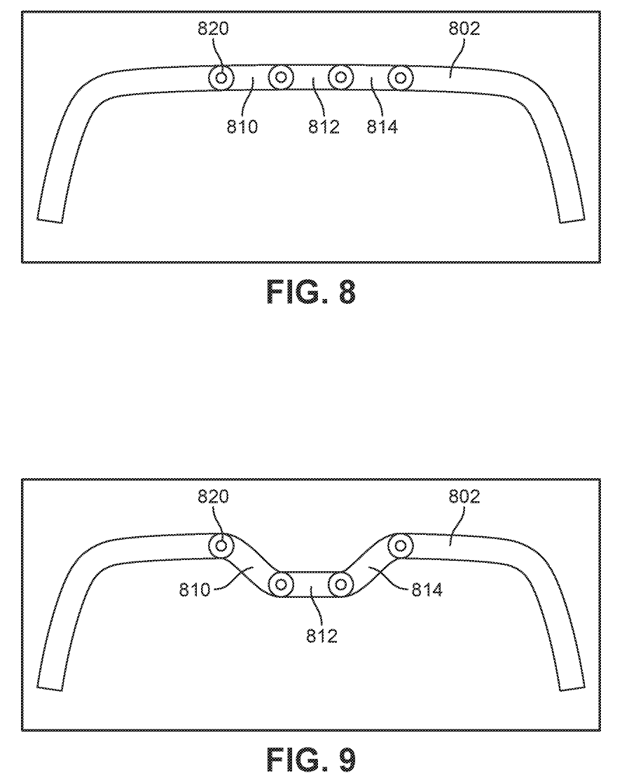

In some embodiments, the shape of each individual support member may be dynamically adjustable. For example, FIGS. 8 and 9 show top-down views of an exemplary support member 802 having a plurality of adjustable segments. These include a first adjustable segment 810, a second adjustable segment 812 and a third adjustable segment 814. These adjustable segments comprise approximately straight segments whose orientation, relative to other adjacent segments, can be modified. For example, in FIG. 8, first adjustable segment 810, second adjustable segment 812 and third adjustable segment 814 are generally colinear or parallel, and so form a relatively straight portion along the rear part of support member 802. By contrast, in FIG. 9, first adjustable segment 810 and third adjustable segment 814 both form an angle with second adjustable segment 812, giving the rear part of support member 802 a non-linear shape. It is noted that first adjustable segment 810, second adjustable segment 812, and third adjustable segment 814 may form angles with each other in an unlimited number of configurations.

In some cases, a support member may be made using linkages and pivot points. For example, in the exemplary embodiments of FIGS. 8-9, the adjustable segments may include internal rods or other linkages that are connected about pivot points 820. In some cases, the pivot points 820 may be implemented with electromechanical actuators that may dynamically adjust the relative orientations of the adjustable segments.

By using support members with adjustable segments, a rear bench may be configured with a variety of different geometries. For example, FIG. 10 illustrates a geometry of rear bench 132 that may be used with a performance mode, or a manual mode, of driving. In this case, rear support surface 344 is more vertical compared to the degree of incline in the configuration of FIG. 3A. Additionally, the geometry of the internal support members is adjusted to give rear surface 344 a convex shape along a central rear surface portion 1002. This convex portion may provide a natural separation at the center to define two distinct seats within rear bench 132.

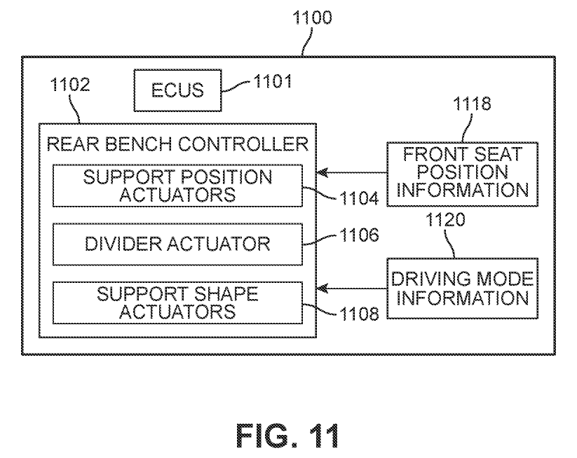

FIG. 11 is a schematic view of a system diagram 1100 of some components of motor vehicle 100 that may facilitate operation of an adaptive rear bench.

In some embodiments, motor vehicle 100 may comprise hardware and software components. In particular, motor vehicle 100 may include one or more electronic control units 1101 (ECUs 1101). ECUs 1101 may comprise one or more discrete computing systems that may each include one or more processors, as well as non-transitory computer-readable media (memory) for storing instructions that may be executed by the one or more processors. Various electronic systems in vehicle 100 may be operated using ECUs and/or any other suitable computing systems with processors and memory.

Motor vehicle 100 may include a rear bench controller 1102. Rear bench controller 1102 may include modules, systems, and/or other components for controlling a rear bench, including changing the configuration (including geometry) of the rear bench. To this end, rear bench controller 1102 may include one or more support position actuators 1104. Such actuators may be used to adjust the positions of one or more internal support structures, for example, the positions of first support member 610, second support member 612, and third support member 614 shown in FIG. 6.

Rear bench controller 1102 may also include one or more divider actuators 1106, which may be used to raise and lower a divider, such as dividing member 660 of FIG. 6. In some cases, divider actuator 1106 may also be used to adjust the position of a horizontal structure that provides a seating surface, such as support layer 690 of FIG. 6. In other cases, a separate actuator may be used to control such a support layer.

Rear bench controller 1102 may also include one or more support shape actuators 1108. These may be used to control the shape of an individual support member. For example, such actuators may be used to change the relative orientations of support member segments, including first segment 810, second segment 812, and third segment 814 in FIGS. 8-9.

In some embodiments, rear bench controller 1102 may further receive various kinds of information. For example, rear bench controller 1102 may receive front seat position information 1118. In some cases, rear bench controller 1102 may receive driving mode information 1120. In some embodiments, rear bench controller 1102 may be configured to automatically adjust the configuration of the rear bench using one or both of front seat position information 1118 and driving mode information 1120. For example, in some cases, reach bench controller 1102 may automatically select a different bench configuration for different driving modes or front seat positions.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A motor vehicle, comprising:
a front seat having a first seat configuration and a second seat configuration;
a rear bench having a first bench configuration and a second bench configuration;
a control system to:
automatically adjust the rear bench to have the first bench configuration when the front seat has the first seat configuration; and
automatically adjust the rear bench to have the second bench configuration when the front seat has the second seat configuration.

2. The motor vehicle according to claim 1, wherein the front seat faces towards a front side of the motor vehicle when the front seat is in the first seat configuration and wherein the front seat faces towards a rear side of the motor vehicle when the front seat is in the second seat configuration.

3. The motor vehicle according to claim 2, wherein the rear bench is adapted to receive an occupant in the first bench configuration and wherein the rear bench is adapted to receive cargo in the second bench configuration.

4. The motor vehicle according to claim 1, wherein the rear bench has a first exterior surface geometry in the first bench configuration and wherein the rear bench has a second exterior surface geometry in the second bench configuration.

5. The motor vehicle according to claim 1, wherein the rear bench is associated with a dividing member, wherein the dividing member is retracted below a lower support surface of the rear bench in the first bench configuration and wherein the dividing member is extended above the lower support surface of the rear bench in the second bench configuration.

6. The motor vehicle according to claim 1, wherein the rear bench has a first exterior surface area in the first bench configuration and wherein the rear bench has a second exterior surface area in the second bench configuration.

7. A motor vehicle, comprising:
a rear bench further comprising:
a plurality of support members, wherein the plurality of support members are independently moveable in a first direction;
at least one outer covering layer disposed over one or more of the plurality of support members;
wherein a geometry of the rear bench changes as the plurality of support members are moved to different positions along the first direction.

8. The motor vehicle according to claim 7, wherein the first direction corresponds to a longitudinal direction of the motor vehicle.

9. The motor vehicle according to claim 7, wherein the at least one outer covering layer is elastic.

10. The motor vehicle according to claim 9, wherein the at least one outer covering layer stretches as the plurality of support members are separated along the first direction.

11. The motor vehicle according to claim 9, wherein the at least one outer covering layer contracts as the plurality of support members are brought closer together along the first direction.

12. The motor vehicle according to claim 7, wherein a surface area of the rear bench changes as the plurality of support members are moved to different positions along the first direction.

13. The motor vehicle according to claim 7, wherein the rear bench further includes a dividing member that is moveable along a second direction.

14. The motor vehicle according to claim 13, wherein the second direction is perpendicular to the first direction.

15. The motor vehicle according to claim 13, wherein the dividing member is used to separate a portion of the rear bench into distinct compartments.

16. A motor vehicle, comprising:
a rear bench including an exterior surface; and
wherein a surface geometry of exterior surface is adjustable.

17. The motor vehicle according to claim 16, wherein the rear bench is configurable in a first configuration and in a second configuration, and wherein a surface area of the exterior surface changes between the first configuration and the second configuration.

18. The motor vehicle according to claim 17, wherein the motor vehicle includes a front seat having a first position and a second position, and wherein the rear bench has the first configuration when the front seat has the first position and wherein the rear bench has the second configuration when the front seat has the second position.

19. The motor vehicle according to claim 18, wherein the exterior surface is comprised of a lower support surface for supporting an occupant’s legs and a rear support surface for supporting an occupant’s back when the rear bench is in the first configuration.

20. The motor vehicle according to claim 18, wherein the second configuration is adapted to receive cargo.
